(19) United States
(12) Patent Application Publication
(10) Pub. No.: US 2019/0282028 A1
(43) Pub. Date: Sep. 19, 2019

(54) GRILL PAN FOR DIRECT FIRED ROAST

(71) Applicants: Jung Wook KIM, Daegu (KR); Tae Suck KIM, Daegu (KR)

(72) Inventors: Jung Wook KIM, Daegu (KR); Tae Suck KIM, Daegu (KR)

(21) Appl. No.: 16/049,036

(22) Filed: Jul. 30, 2018

(30) Foreign Application Priority Data
Mar. 16, 2018 (KR) 10-2018-0030933

(51) Int. Cl. A47J 37/06; A47J 37/10

(52) U.S. Cl. CPC A47J 37/067; A47J 37/10

(57) ABSTRACT

The present invention relates to a grill pan for a direct fired roast including a side wall, and a bottom surface of a grill pan main body surrounded by the side wall. The bottom surface includes: an oil collecting part concavely formed in the bottom surface along a lower end of the side wall; a plurality of lower ribs formed at an upper surface thereof with a first oil passage connected to the oil collecting part, and spaced apart from each other at a predetermined interval; a plurality of upper ribs located higher than the lower ribs, formed at an upper surface thereof with a second oil passage connected to the oil collecting part, and spaced apart from each other at a predetermined interval; and a heat outlet formed between a lower portion of the upper rib and an upper portion of the lower rib to discharge heat.

### BACKGROUND OF THE INVENTION

### 1. Field of the Invention

The present invention relates to a grill pan for a direct fired roast, and more particularly, to a grill pan for a direct fired roast used for roasting foods such as meat or fish in a direct firing scheme.

### 2. Description of the Related Art

In general, as a scheme of roasting foods such as meat or fish, there are a direct firing scheme in which a fire of a heating means such as a gas stove or charcoal fire makes direct contact with the foods to roast the foods, and an indirect heating scheme in which the foods are indirectly heated and roasted through a roasting plate heated by the fire of the heating means.

The direct firing scheme is preferred because the taste and flavor of the roasted meat is excellent and the taste of the roasted meat can be the taste of the barbecue. To this end, there are proposed a variety of ways to roast the meat or the like in the direct firing scheme even at home. Meanwhile, a grill pan for a direct fired roast has a plurality of holes, so that the holes are used to allow the fire of the heating means such as the gas stove or the charcoal fire to pass.

However, according to the conventional double-structure grill pan for the direct fired roast, two metal plates are individually processed to manufacture a roasting plate and an oil receiving plate, and the two metal plates are coupled to each other such that the two plates can be arranged up and down. Therefore, a manufacturing cost is high, and the configuration is complicated because a part for coupling the two plates to each other is required.

In addition, according to the conventional double-structure grill pan for the direct fired roast, since two separate plates are arranged up and down and coupled to each other, the heat conduction is not facilitated, so that thermal efficiency is reduced.

In addition, according to the conventional double-structure grill pan for the direct fired roast, it is difficult to clean the grill pan because the oil or foods may be caught in a coupling region of the two plates, and a cleaning operation is difficult and time-consuming because the two plates have be separated so as to be cleaned.

In order to solve such problems, the inventor of the present invention has invented a double-structure grill pan for a direct fired roast, which has been registered as Korean Patent Registration Publication No. 10-1550016.

The double-structure grill pan for the direct fired roast disclosed in Korean Patent Registration Publication No. 10-1550016 includes: a bottom plate including a plurality of upper ribs spaced apart from each other at a first horizontal interval, a plurality of lower ribs spaced apart from each other at a second horizontal interval, spaced apart from the upper ribs at a predetermined vertical interval such that the lower ribs are disposed directly under spaces defined by the first horizontal interval, having a width greater than the first horizontal interval, and formed in an upper surface thereof with a concave oil receiving groove for receiving oil falling down through the first horizontal interval, an edge part connecting both ends of the upper ribs and both ends of the lower ribs while surrounding the upper ribs and the lower ribs, and formed in an upper surface thereof with a concave oil accommodation groove connected to the oil receiving groove; and a side wall formed at a periphery of the bottom plate, wherein the bottom plate and the side wall are integrally formed by casting work or by using a single metal plate.

However, according to the double-structure grill pan for the direct fired roast disclosed in Korean Patent Registration Publication No. 10-1550016, when the meat is placed on the upper rib and roasted, the oil discharged from the meat may fall down through the first horizontal interval so as not to enter the concave oil receiving groove of the lower rib that receives the oil, and the oil may be burned by the heat rising from the heating means disposed at a lower portion such as the gas stove or the charcoal fire so as to generate smoke or soot.

In addition, when the meat is placed on the upper rib and roasted, the oil discharged from the meat hardens in the first horizontal interval and a gap between the upper and lower ribs, so that the heat may not rise through the gap, and moisture at a surface of the meat may not be removed, thereby deteriorating the taste of the meat.

Meanwhile, Korean Patent Application Publication No. 10-2011-0005067 discloses a roaster using a profile having a sectional shape of ‘L’. According to Korean Patent Application

Publication No. 10-2011-0005067, a grill pan for a direct fired roast is manufactured by rotating a profile having a sectional shape of ‘L’ by about 45°, inserting the profile into a vertically standing side plate, and arranging the above configuration side by side at a predetermined interval, and two grills are offset from each other such that shoulder portions of the profile partially overlap with each other.

However, according to the grill pan for the direct fired roast disclosed in Korean Patent Application Publication No. 10-2011-0005067, the profile inserted into the side plate may be separated from the side plate with long-term use. In addition, it is difficult to clean the grill pan for the direct fired roast because foreign substances may be caught in a gap between the side plate and the profile.

### DOCUMENTS OF RELATED ART

### Patent Documents

(Patent document 0001) Korean Utility Model Registration Publication No. 10-2009-0049628

(Patent document 0002) Korean Patent Registration Publication No. 10-1550016

(Patent document 0003) Korean Patent Application Publication No. 10-2011-0005067

(Patent document 0004) United States Patent No. 67,6479

(Patent document 0005) United States Application Publication No. US2016/028701SA1

### SUMMARY OF THE INVENTION

To solve the above-described problems of the related art, an object of the present invention is to provide a grill pan for a direct fired roast, in which when meat is placed on an upper rib and roasted, oil discharged from the meat enters a concave oil receiving groove of a lower rib that receives the oil, and even when an excessive amount of oil is discharged from the meat, the oil is collected in an oil accommodation groove.

To achieve the object described above, according to the present invention, there is provided a grill pan for a direct fired roast including a side wall extending upwards in a curved shape, and a bottom surface of a grill pan main body surrounded by the side wall, wherein the bottom surface of the grill pan main body includes: an oil collecting part concavely formed in the bottom surface of the grill pan main body along a lower end of the side wall; a plurality of lower ribs surrounded by the oil collecting part, formed at an upper surface thereof with a first oil passage connected to the oil collecting part, and spaced apart from each other at a predetermined interval; a plurality of upper ribs located higher than the lower ribs, surrounded by the oil collecting part, formed at an upper surface thereof with a second oil passage connected to the oil collecting part, and spaced apart from each other at a predetermined interval, such that one edge of the upper rib overlaps with an inner portion of one lower rib, and an opposite edge of the upper rib overlaps with an inner portion of another adjacent lower rib when viewed from a top; and a heat outlet formed between a lower portion of the upper rib and an upper portion of the lower rib to discharge heat, in which oil discharged from meat flows into the oil collecting part through the first oil passage and the second oil passage.

In addition, the oil collecting part may be formed at a lowest position on the bottom surface of the grill pan main body. Further, each of the first oil passage and the second oil passage may have a gradient gradually lowered from a longitudinal center portion thereof toward the oil collecting part so as to allow the oil to flow into the oil collecting part.

In addition, the meat may be laid over a part of the upper ribs. At this time, the meat may be put on a part of the lower ribs.

In addition, the upper ribs may be provided with stoppers for preventing the meat from slipping downwards, respectively.

In addition, the bottom surface of the grill pan main body may be divided into the lower ribs, which are defined by lower spaces, and the upper ribs, which are defined by upper spaces.

In addition, the lower ribs and the upper ribs may be arranged in a three-dimensional structure, which is a double structure in which the lower ribs and the upper ribs are located at different vertical positions from the bottom surface of the grill pan main body.

According to the grill pan for the direct fired roast of the present invention, the oil can be reduced by roasting the foods such as the meat or fish by the direct firing scheme, so that low-calorie foods with good taste and flavor can be provided.

Particularly, according to the grill pan for the direct fired roast of the present invention, since the bottom plate has a double structure in which a plurality of upper ribs and a plurality of lower ribs are arranged up and down, and the grill pan can be integrally formed by processing a single metal plate, there is no gap in the grill pan so that foreign substances cannot be caught in the gap, and a portion for coupling two plates is unnecessary so that the configuration of the grill pan is simple and the manufacturing cost is reduced.

In addition, according to the grill pan for the direct fired roast of the present invention, since the grill pan is formed by using a single metal plate as described above, the heat conduction is facilitated, so that the thermal efficiency can be improved.

Further, according to the grill pan for the direct fired roast of the present invention, the configuration is simple as described above, and the oil receiving grooves formed in the upper surfaces of the lower ribs are exposed through the first horizontal interval defined between the upper ribs.

### BRIEF DESCRIPTION OF THE DRAWINGS

FIG. 1 is a perspective view showing a grill pan for a direct fired roast according to one embodiment of the present invention.

FIG. 2 is a plan view showing the grill pan for the direct fired roast.

FIG. 3 is a vertical sectional view showing the grill pan for the direct fired roast taken along a line shown in FIG. 2.

FIG. 4 is an enlarged view showing a portion IV surrounded by a circle in FIG. 3.

FIG. 5 is an enlarged view showing a part of FIG. 4.

FIG. 6 is a partial perspective view showing the grill pan for the direct fired roast shown in FIG. 1 when FIG. 1 is cut along a line VI-VI.

FIG. 7 is a partial perspective view showing an overturned state of an opposite side of the grill pan for the direct fired roast shown in FIG. 1 when FIG. 1 is cut along the line VI-VI.

FIG. 8 is a perspective view showing a dual-side grill pan for a direct fired roast in which upper and lower grill pans for the direct fired roast are overlapped in use.

FIG. 9 is a sectional view showing the grill pan for the direct fired roast taken along a line IX-IX in FIG. 8.

FIG. 10 is an exploded perspective view showing a disassembled state of the upper and lower grill pans for the direct fired roast shown in FIG. 8.

FIG. 11 is a perspective view showing the lower grill pan for the direct fired roast shown in FIG. 8.

FIG. 12 is a perspective view showing the upper grill pan for the direct fired roast shown in FIG. 8.

### DETAILED DESCRIPTION OF THE INVENTION

Hereinafter, a grill pan for a direct fired roast according to the present invention will be described in detail with reference to the accompanying drawings.

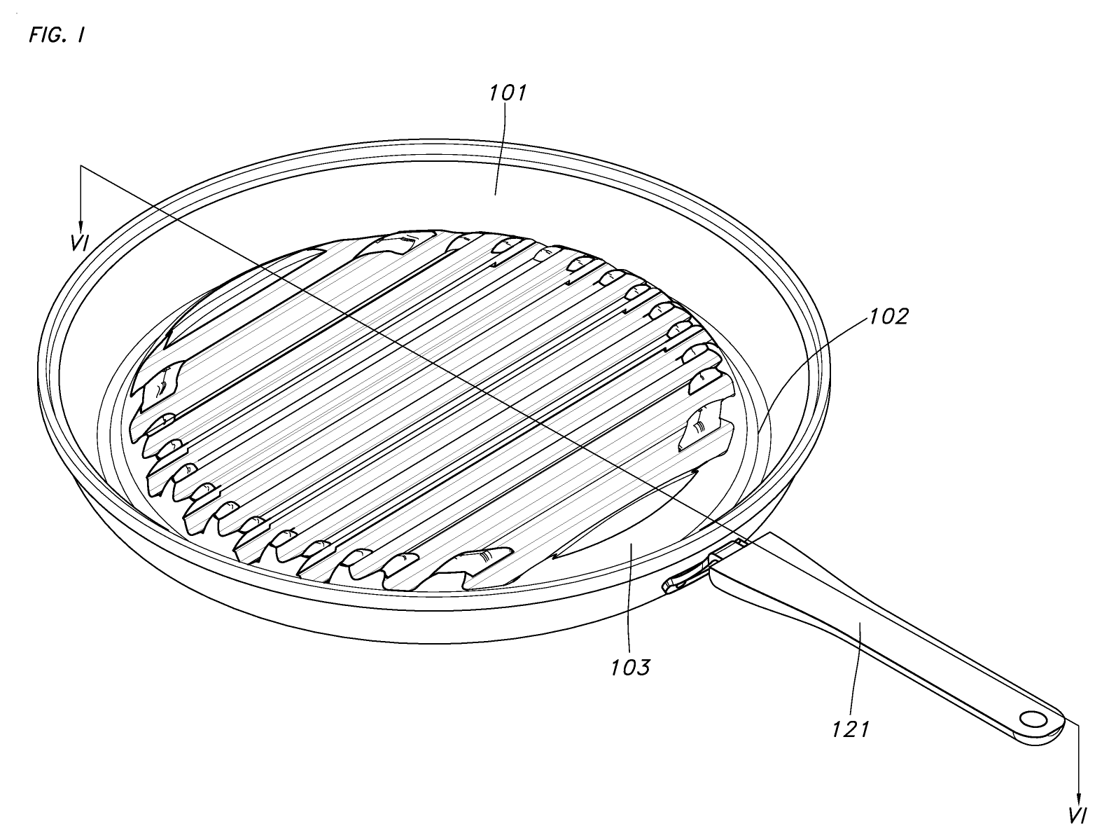

FIG. 1 is a perspective view showing a grill pan for a direct fired roast according to one embodiment of the present invention.

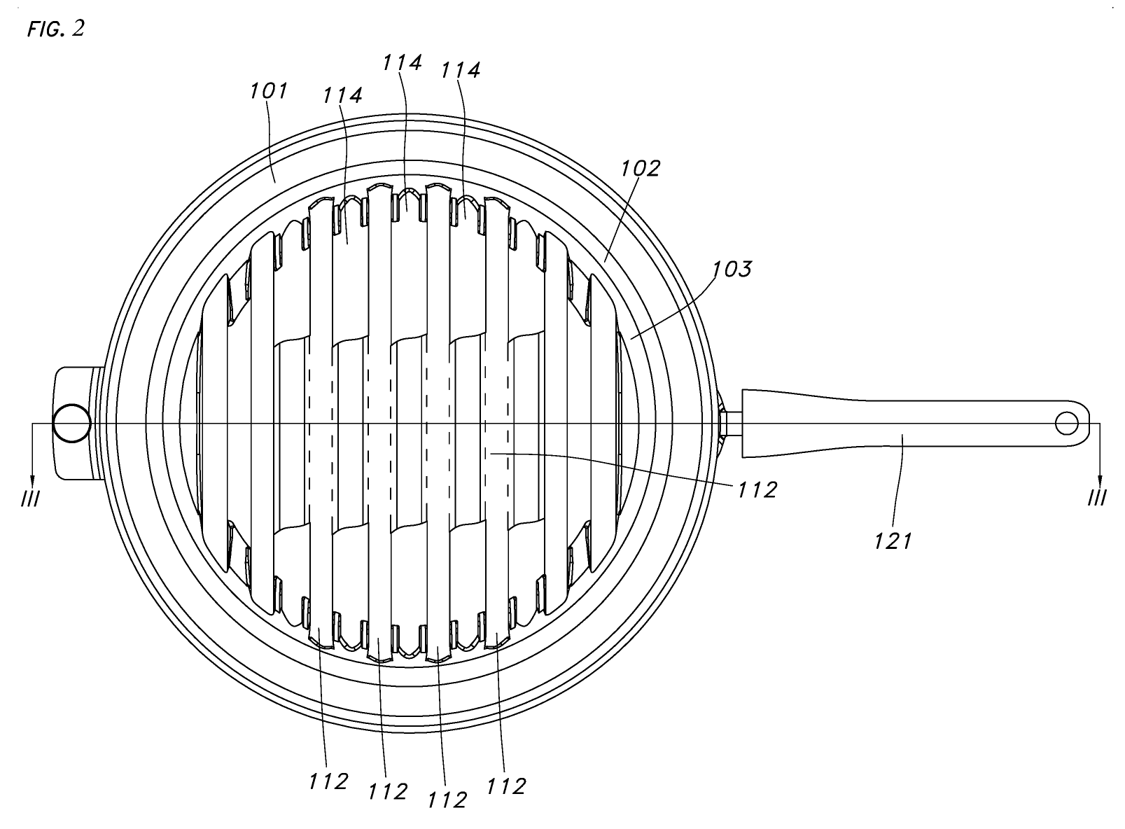

FIG. 2 is a plan view showing the grill pan for the direct fired roast, in which a part of an upper rib is cut so that a lower rib can be viewed.

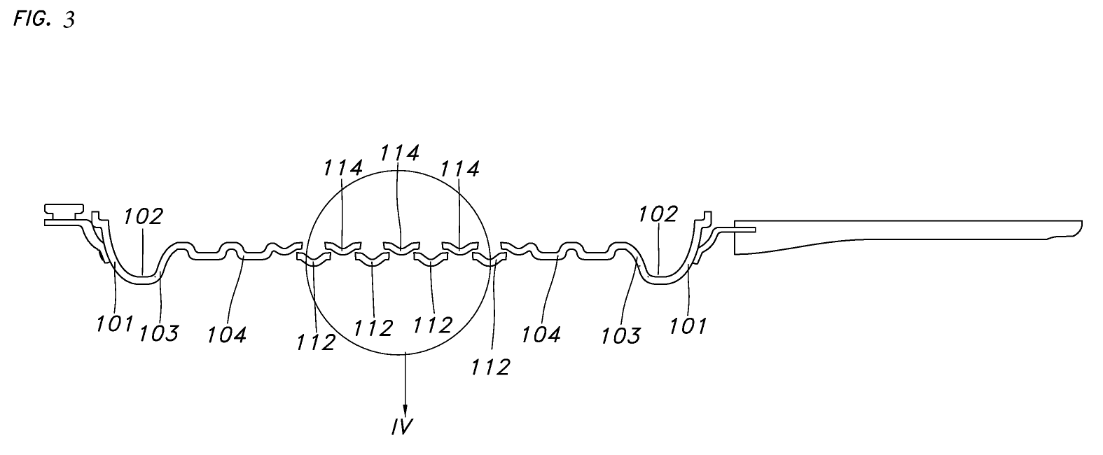

FIG. 3 is a vertical sectional view showing the grill pan for the direct fired roast taken along a line III-III shown in FIG. 2.

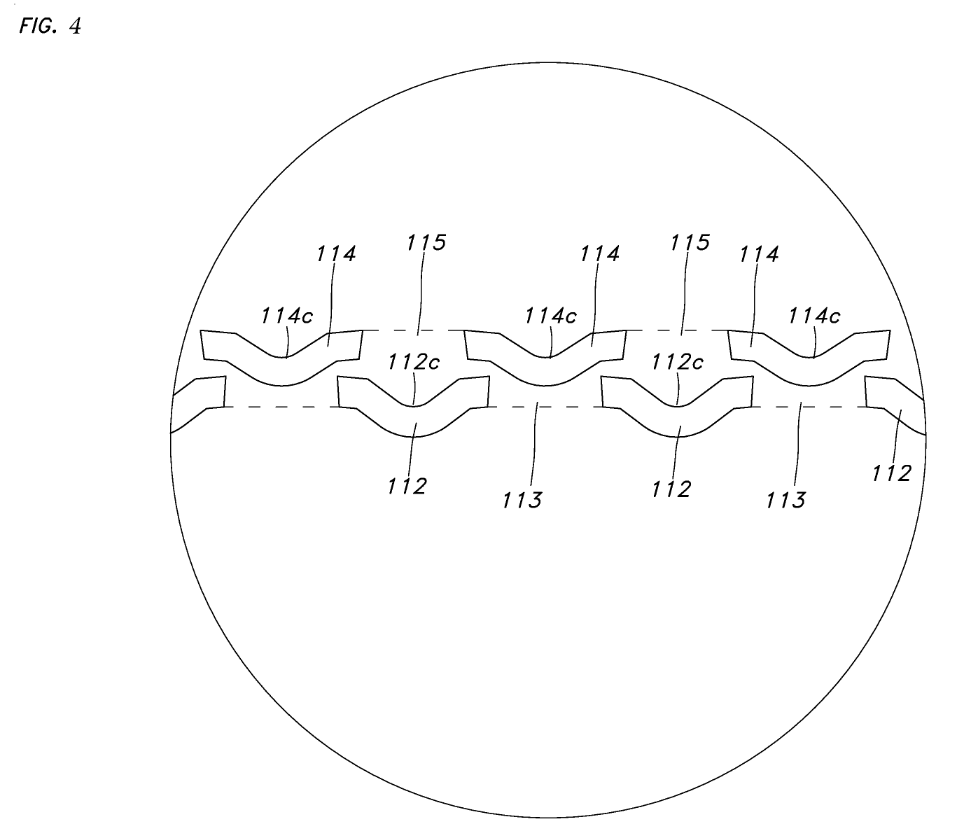

FIG. 4 is an enlarged view showing a portion IV surrounded by a circle in FIG. 3.

First, referring to FIGS. 1 to 4, a grill pan 100 for a direct fired roast according to one embodiment of the present invention is a cooking container used for roasting foods such as meat, fish or the like in a direct firing scheme, and is formed in a double structure by using a single metal plate.

The grill pan 100 for the direct fired roast includes a side wall 101 extending upwards in a curved shape, and a bottom surface 104 of a grill pan main body surrounded by the side wall 101. The bottom surface 104 of the grill pan main body includes a lower rib 112 having a periphery attached to a slope 103 extending upwards from an oil collecting part 102 concavely formed in the bottom surface 104 of the grill pan main body along a lower end of the side wall 101, and an upper rib 114 disposed at an upper portion of the lower rib 112 and having a periphery attached to the slope 103 at a predetermined interval.

It should be understood that the terms ‘lower rib 112’ and ‘upper rib 114’ in the description of the present invention are used for convenience in describing the structure of the present invention, and the lower ribs 112 and the upper ribs 114 are integrally formed in a manufacturing process. The manufacturing process used in the above technique is disclosed in Korean Patent Registration Publication No. 10-1550016, which is the related art invented by the inventor of the present invention, and the manufacturing process can be applied in manufacturing the present invention.

The bottom surface 104 of the grill pan 100 for the direct fired roast is attached to a periphery of the slope 103 extending upwards from the oil collecting part 102. A part of the bottom surface 104 of the grill pan 100 for the direct fired roast is separated into a plurality of ribs by spaces 113 and 115 formed at a predetermined interval. The bottom surface 104 of the grill pan 100 for the direct fired roast is divided into a plurality of lower ribs 112, which are separated by the spaces 113 formed at a predetermined interval and located at a lower position, and a plurality of upper ribs 114, which are separated by the spaces 115 formed at a predetermined interval and located higher than the lower ribs 112.

A lower oil passage 112c having a sectional shape of ‘U’ is formed in an upper surface of each of the lower ribs 112. The lower oil passage 112c formed in the upper surface of each of the lower ribs 112 is connected to the oil collecting part 102, so that the oil flowing into the lower oil passage 112c can flow down to the oil collecting part 102.

An upper oil passage 114c having a sectional shape of ‘U’ is formed in an upper surface of each of the upper ribs 114. The upper oil passage 114c formed in the upper surface of each of the upper ribs 114 is connected to the oil collecting part 102, so that the oil flowing into the upper oil passage 114c can flow down to the oil collecting part 102.

Each of the lower ribs 112 is located under the upper space 115 of the upper rib 114, and each of the upper ribs 114 is located above the lower space 113 of the lower rib 112. In other words, each of the lower ribs 112 is located under the upper space 115 of the upper rib 114, and each of the upper ribs 114 is located above the lower space 113 of the lower rib 112, such that the upper ribs 114 are disposed alternately with the lower ribs 112.

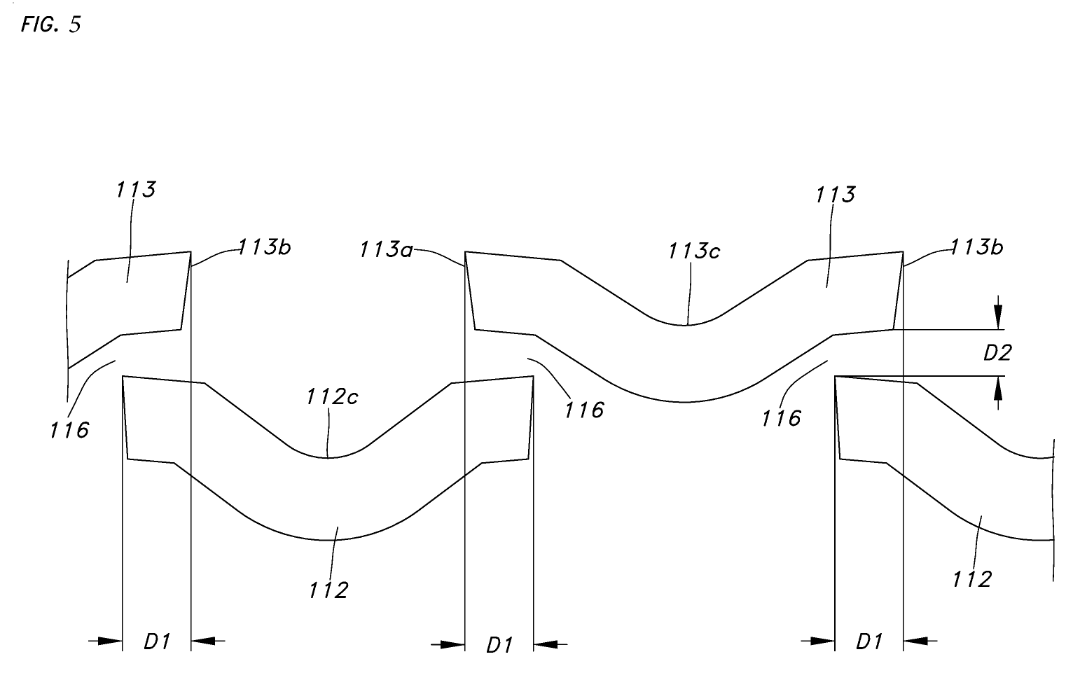

In addition, as shown in FIG. 5, the upper rib 114 located above the lower space 113 of the lower rib 112 has one edge 114a partially overlapping with a lower rib 112, and an opposite edge 114b partially overlapping with another lower rib 112 adjacent to a lower space 113 of the lower rib 112 by a width D1 when viewed from a top. Accordingly, when oil discharged from meat as the meat is placed on the upper rib 114 and roasted falls into the upper oil passage 114c formed in the upper surface of the upper rib 114, all of the oil can flow into the lower oil passage 112c of the lower rib 112 and flow down to the oil collecting part 102.

The lower rib 112 is located under the space 115 between the upper ribs 114 while being spaced apart from the space 115 by a second vertical interval D2.

A slot 116 defined by the vertical interval D2 is formed between the lower rib 112 and the space 115 of the upper rib 114, so that heat rising from a bottom through the lower space 113 comes out of the slot 116 and rises to a top through the upper space 115. As the heat rising from the bottom through the lower space 113 comes out of the slot 116 and rises to the top through the upper space 115, the heat serves to remove the moisture from the surface of the meat placed on the upper rib 114 and to roast the meat, thereby enriching the flavor as if the meat is directly roasted at a fire.

The lower ribs 112 are located under the upper ribs 114 while being spaced apart from the upper ribs 114 by a vertical interval D2, and is formed at the upper surface thereof with a concave oil receiving groove 112c. In addition, the lower ribs 112 are located under the upper ribs 114 while being spaced apart from the upper ribs 114 by a predetermined vertical interval D2. In particular, the lower ribs 112 are located directly under the upper ribs 114 while being spaced apart from the upper ribs 114 by the vertical interval D2. In other words, the upper ribs 114 and the lower ribs 112 are arranged in an up-down double structure, while being alternately arranged with each other.

In addition, a width of the lower rib 112 is larger than a horizontal interval of the upper space 115 such that the lower rib 112 can receive all of the oil falling down through the upper space 115. Particularly, a width of the oil receiving groove 112c formed in the upper surface of the lower rib 112 may be equal to the horizontal interval of the upper space 115 or slightly larger than the horizontal interval of the upper space 115.

According to the above-described configuration, since the heat of the heating means such as the gas stove or the charcoal fire makes direct contact with the meat placed on the upper surface of the upper rib 114, the foods can be roasted in a direct firing scheme.

In addition, the oil from the upper ribs 114 is received by oil accommodation grooves 112c formed in the upper surfaces of the lower ribs 112 installed directly under the upper ribs 114, so that it is possible to prevent the gas stove from being contaminated as the oil falls down, or to prevent smoke and soot from being generated as the oil makes direct contact with the fire so as to be burned.

A bottom plate 110 may have a rectangular shape, and the oil collecting part 102 may correspondingly have a rectangular shape.

In addition, the upper ribs 114 and the lower ribs 112 may be inclined such that the upper ribs 114 and the lower ribs 112 are gradually lowered from a longitudinal center portion thereof toward both ends thereof, that is, toward the oil collecting part 102. Further, a bottom surface of the oil collecting part 102 is located lower than the oil receiving grooves 112c formed in the upper surfaces of the lower ribs 112. According to the above structure, the oil fallen into the oil accommodation groove 112c can smoothly flow down to the oil collecting part 102.

According to the above-described structure, the bottom plate 110 is configured such that the upper ribs 114 and the lower ribs 112 are partially arranged in the up-down double structure. However, the bottom plate 110 may be integrally formed by using a single metal plate.

According to the present invention, a grill pan for a direct fired roast includes a side wall extending upwards in a curved shape, and a bottom surface of a grill pan main body surrounded by the side wall, wherein the bottom surface of the grill pan main body includes: an oil collecting part concavely formed in the bottom surface of the grill pan main body along a lower end of the side wall; a plurality of lower ribs surrounded by the oil collecting part, formed at an upper surface thereof with a first oil passage connected to the oil collecting part, and spaced apart from each other at a predetermined interval; a plurality of upper ribs located higher than the lower ribs, surrounded by the oil collecting part, formed at an upper surface thereof with a second oil passage connected to the oil collecting part, and spaced apart from each other at a predetermined interval, such that one edge of the upper rib overlaps with an inner portion of one lower rib, and an opposite edge of the upper rib overlaps with an inner portion of another adjacent lower rib when viewed from a top; and a heat outlet formed between a lower portion of the upper rib and an upper portion of the lower rib to discharge heat, in which oil discharged from meat flows into the oil collecting part through the first oil passage and the second oil passage. The grill pan for the direct fired roast can be used in manufacturing a dual-side grill pan for a direct fired roast including a lower grill pan for a direct fired roast, and an upper grill pan for a direct fired roast coupled to the lower grill pan for the direct fired roast, wherein the dual-side grill pan is overturnable in use.

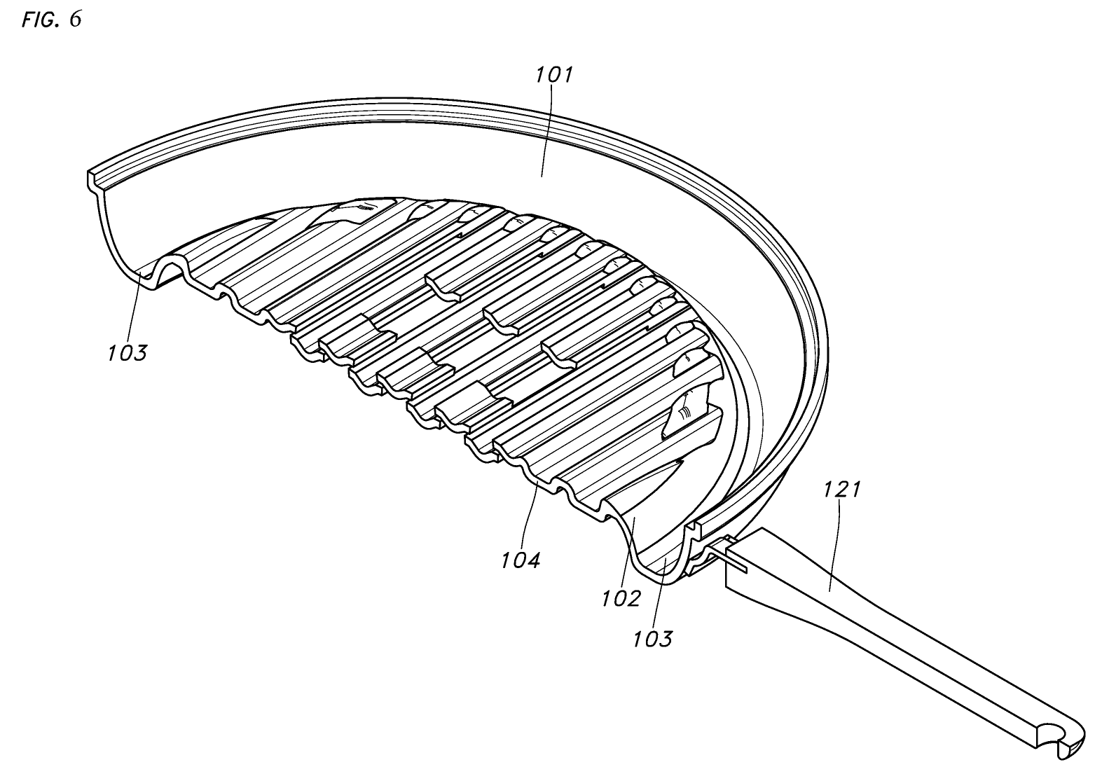

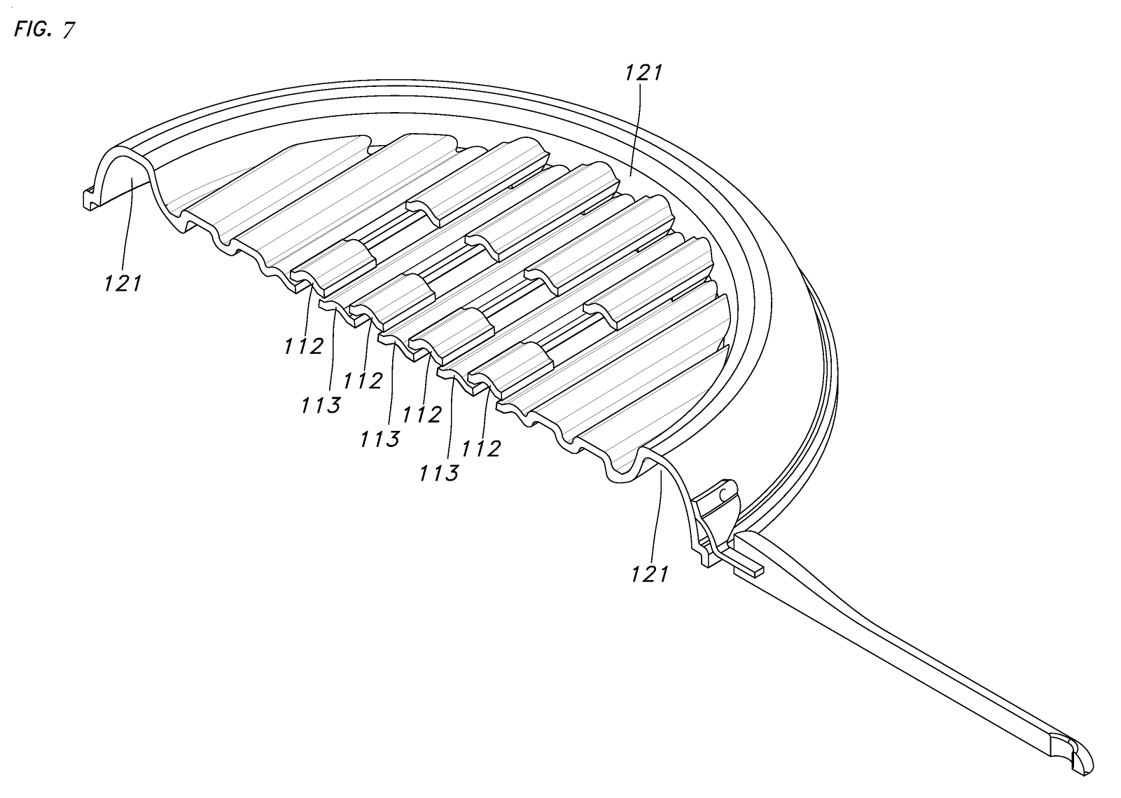

The dual-side grill pan for the direct fired roast has the same configuration as the configurations shown in FIGS. 1 to 7, except for a structure for easily coupling two grill pans for the direct fired roast.

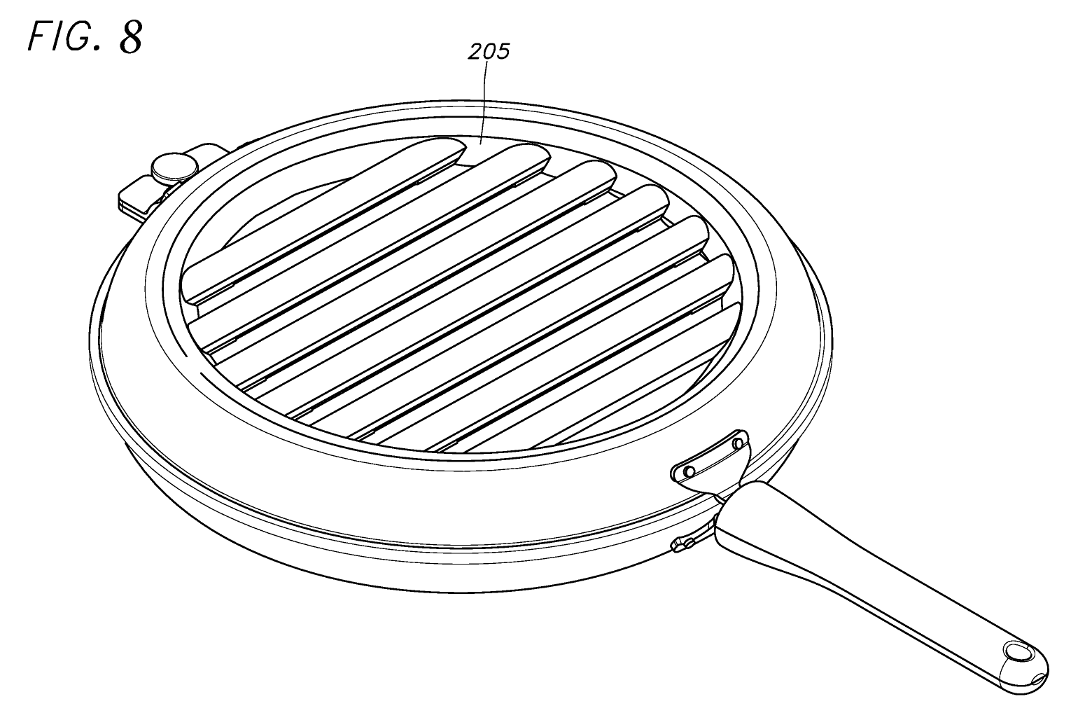

FIG. 8 is a perspective view showing a dual-side grill pan for a direct fired roast in which upper and lower grill pans for the direct fired roast are overlapped in use.

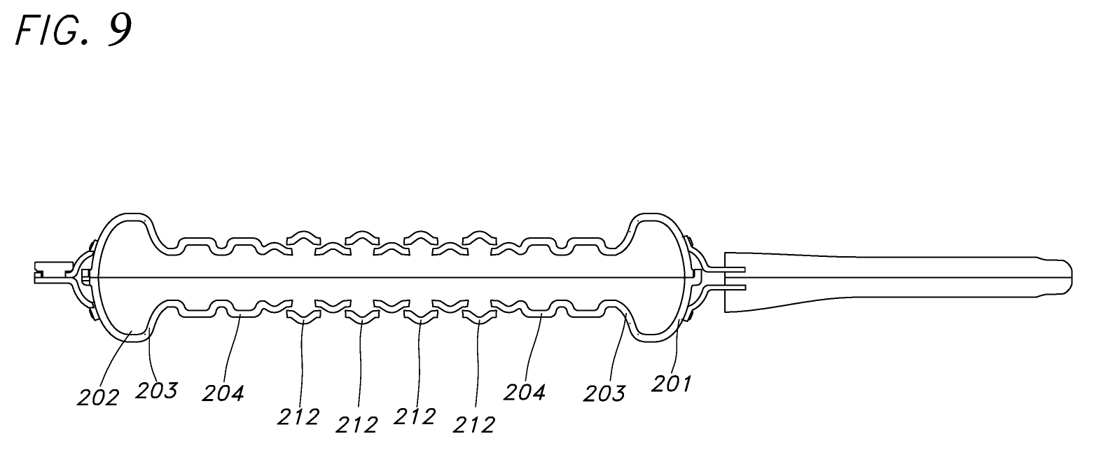

FIG. 9 is a sectional view showing the grill pan for the direct fired roast taken along a line IX-IX in FIG. 8.

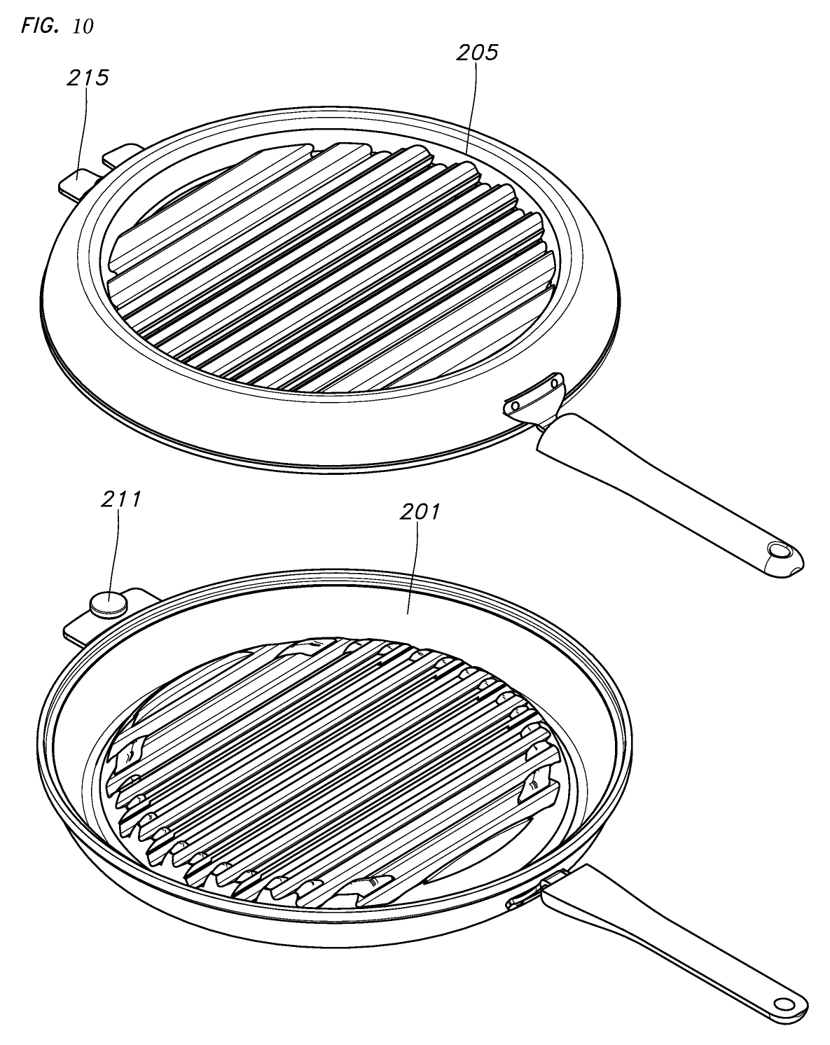

FIG. 10 is an exploded perspective view showing a disassembled state of the upper and lower grill pans for the direct fired roast shown in FIG. 8.

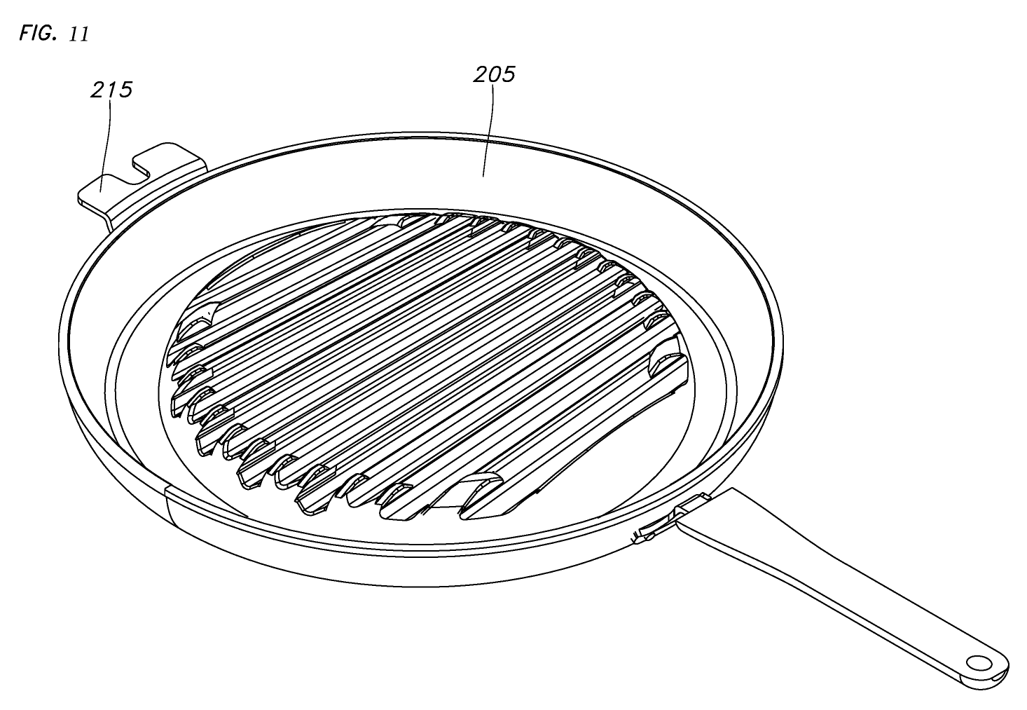

FIG. 11 is a perspective view showing the lower grill pan for the direct fired roast shown in FIG. 8.

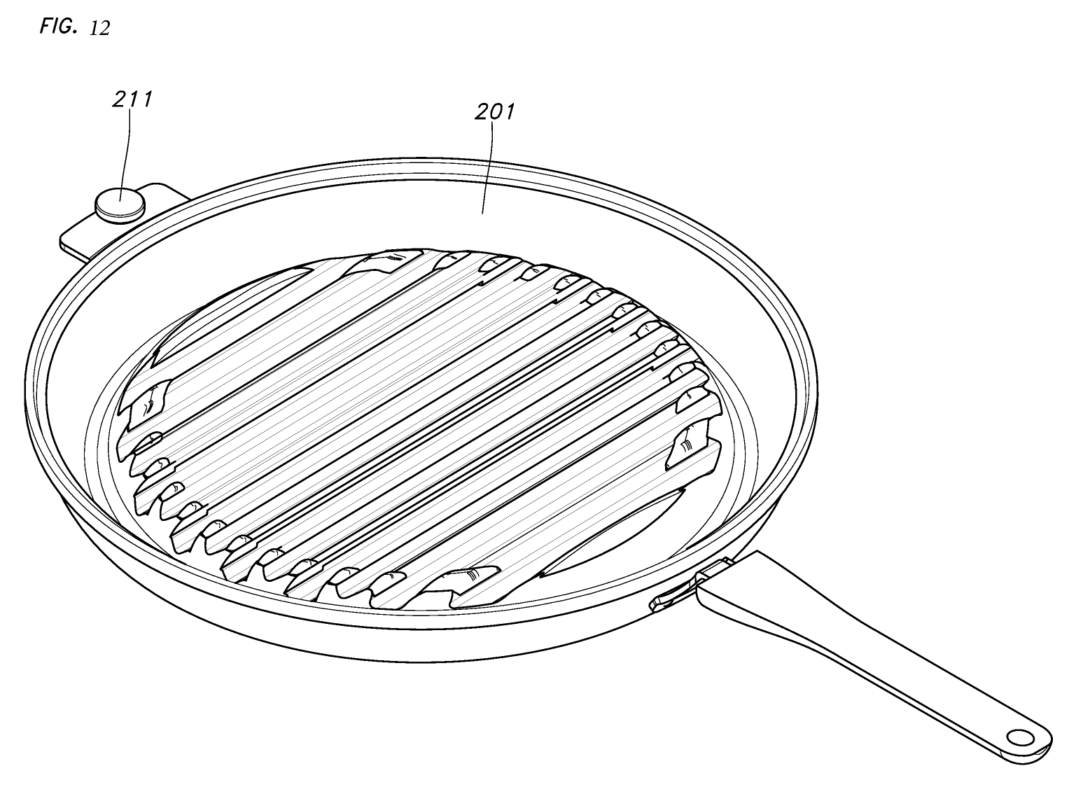

FIG. 12 is a perspective view showing the upper grill pan for the direct fired roast shown in FIG. 8.

Referring to FIGS. 8 to 12, the lower grill pan for the direct fired roast is provided with a coupling member supporting part 211 and a snap part 213 attached to the coupling member supporting part 211, and the upper grill pan for the direct fired roast is formed with a U-shaped opening 215 fitted to the coupling member supporting part 211 of the lower grill pan for the direct fired roast.

Therefore, the U-shaped opening 215 of the upper grill pan for the direct fired roast is inserted into the snap part 213 attached to the coupling member supporting part 211 of the lower grill pan for the direct fired roast, so that the upper grill pan for the direct fired roast can be easily coupled to the lower grill pan for the direct fired roast.

Meanwhile, the U-shaped opening 215 may be formed in the lower grill pan for the direct fired roast, and the snap part 213 attached to the coupling member supporting part 211 may be provided in the upper grill pan for the direct fired roast.

What is claimed is:

1. A grill pan for a direct fired roast including a side wall extending upwards in a curved shape, and a bottom surface of a grill pan main body surrounded by the side wall, wherein the bottom surface of the grill pan main body comprises:
an oil collecting part concavely formed in the bottom surface of the grill pan main body along a lower end of the side wall;
a plurality of lower ribs surrounded by the oil collecting part, formed at an upper surface thereof with a first oil passage connected to the oil collecting part, and spaced apart from each other at a predetermined interval;
a plurality of upper ribs located higher than the lower ribs, surrounded by the oil collecting part, formed at an upper surface thereof with a second oil passage connected to the oil collecting part, and spaced apart from each other at a predetermined interval, such that one edge of the upper rib overlaps with an inner portion of one lower rib, and an opposite edge of the upper rib overlaps with an inner portion of another adjacent lower rib when viewed from a top; and
a heat outlet formed between a lower portion of the upper rib and an upper portion of the lower rib to discharge heat, in which oil discharged from meat flows into the oil collecting part through the first oil passage and the second oil passage.

2. The grill pan of claim 1, wherein each of the first oil passage and the second oil passage has a gradient gradually lowered from a longitudinal center portion thereof toward the oil collecting part to allow the oil to flow into the oil collecting part.

3. The grill pan of claim 2, wherein the meat is laid over a part of the upper ribs.

4. The grill pan of claim 3, wherein the upper ribs are provided with stoppers for preventing the meat from slipping downwards, respectively.

5. The grill pan of claim 1, wherein the meat is laid over a part of the upper ribs.

6. The grill pan of claim 5, wherein the upper ribs are provided with stoppers for preventing the meat from slipping downwards, respectively.

7. The grill pan of claim 1, wherein the upper ribs are provided with stoppers for preventing the meat from slipping downwards, respectively.

8. A dual-side grill pan for a direct fired roast, the dual-side grill pan comprising:
a lower grill pan for a direct fired roast, having a structure of the grill pan according to claim 1; and
an upper grill pan for a direct fired roast, having a structure of the grill pan according to claim 1, and coupled to the lower grill pan for the direct fired roast,
wherein the dual-side grill pan is overturnable in use.
